(19) United States
(12) Patent Application Publication
(10) Pub. No.: US 2008/0053315 A1
(43) Pub. Date: Mar. 6, 2008

(54) GRILLING AND COOKING APPARATUS

(76) Inventors: Ray Nicholas, Ingleside, IL (US); Debra F. Nicholas, Ingleside, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/309,651

(22) Filed: Sep. 5, 2006

(51) Int. Cl. A47J 37/12

(52) U.S. Cl. 99/403

(57) ABSTRACT

A cooking apparatus is disclosed. The cooking apparatus has a substantially cylindrical body and a removable tray assembly. The substantially cylindrical body has an outer surface and an inner surface, a substantially closed first end, and an open second end. The inner surface and the first end define a cooking chamber. Tray support members are disposed laterally across the interior of the body to support the removable tray assembly in various positions. The removable tray assembly includes a food receiving grate having a bottom member and a substantially circular lid member. A tray handle may be connected to the lid member. The food receiving grate may also include a pair of side members connected to and substantially perpendicular to the bottom member, and a back member connected to and substantially perpendicular to the bottom member.

### BACKGROUND OF THE INVENTION

The present invention relates to cooking apparatuses, and more specifically to a grilling and cooking apparatus, and even more specifically to a portable grilling and cooking apparatus.

### DESCRIPTION OF THE RELATED ART

Cooking food over a flame dates back well into prehistoric times. Ever since these prehistoric times, people have sought to improve on the way food is cooked. Nonetheless, there remains a certain appeal to grilling and barbequing food. From jumbo barbeque pits the size of a truck to the most compact of camping stoves, there is seemingly an infinite variety of outdoor cooking apparatuses.

Moving forward to the present time, a number of portable grille devices have been developed. Furthermore there are numerous devices for accelerating the igniting and heating of charcoal or other combustible fuel used in these devices. Charcoal igniters of the “chimney” type are most typified by U.S. Design Patent No. 366,392 and U.S. Utility Pat. No. 5,469,835, both assigned to the Weber-Stephen Products Co. According to these inventions, the charcoal igniting apparatus has a generally cylindrical housing, a charcoal support member disposed in the housing, a heat shield disposed on the outside of the housing, and handles that provide for handling of the apparatus.

U.S. Pat. No. 2,920,614, issued to Phelps, shows a rectangular shaped “chimney” for starting charcoal that has two sets of apertures in the chimney for receiving sets of tines. A lower set of tines can be used to hold the charcoal and an upper set of tines can be used as a cooking surface. In one shown embodiment, a panel on the chimney can by moved such that the chimney may lie on its side and the sets of tines placed across a now exposed top side of the chimney and the sets of tines used for cooking.

Similarly, U.S. Pat. No. 4,023,553, issued to London et al. discloses a combination charcoal lighter and miniature grill. The charcoal lighter is of the chimney type, having a tubular housing with draft openings in the lower portion and a grate loosely positioned within the housing. Hanger rods pivotably support the grate. The grate can pivot from a raised position used while the charcoal is being ignited, and a lowered position where the charcoal can be deposited onto a grille. Optionally, a perforated plate can be placed across the top of the tubular member and used as a cooking surface.

In both of the above referenced patents, the cooking surface is exterior to the apparatus. In these arrangements, the food is cooked using direct heating only. However, indirect heating and often a combination of direct and indirect heating of the food is desirable. Furthermore, wind and other elements of nature are more likely to affect the cooking of the food in these arrangements. Conventional grilles, whether designed for portability or designed to be relatively stationary, provide lids to create a cooking chamber. Furthermore, many of these grilles offer multiple positions for food such that the food can be placed a desired distance away from the heat source and thus provide for direct and indirect heating of the food.

In view of the deficiencies cited above, there remains a need for a cooking apparatus that acts as a charcoal igniter and a grill offering a cooking chamber for direct and indirect heating of food. Thus, it would be advantageous to provide a cooking apparatus that acts as a charcoal igniter and a grill offering a cooking chamber for direct and indirect heating of food.

### SUMMARY

It is an object of the present invention to provide a cooking apparatus that acts as a charcoal igniter and a grill offering a cooking chamber for direct and indirect heating of food.

The present invention is a cooking apparatus. The cooking apparatus has two primary components: a substantially cylindrical body and a removable tray assembly. The substantially cylindrical body has an outer surface and an inner surface, a substantially closed first end, and an open second end. The inner surface and the first end define a cooking chamber. Tray support members are disposed laterally across the interior of the body. The tray support members serve to support the removable tray assembly in various positions. An air inlet allows air into the cooking chamber to promote combustion of the combustible fuel used in the apparatus. An ash exit port can be located towards the bottom of the first end. Legs may be used to support the body up off the ground or other object the apparatus is placed upon and prevent the body from rolling.

In various preferred embodiments, the body also includes an access port to allow access into the cooking chamber. A handle assembly, including a handle support and handle may also be connected to the body.

The removable tray assembly includes a food receiving grate having a bottom member and a substantially circular lid member. A tray handle may be connected to the lid member. The food receiving grate may also include a pair of side members connected to and substantially perpendicular to the bottom member, and a back member connected to and substantially perpendicular to the bottom member. An L-shaped tab may also be connected to the body for retaining the lid member in a closed position, which is with the tray assembly fully slid into the body.

In use, the body is placed in a vertical position. A combustible fuel, such as charcoal, is placed into the body. The fuel is ignited and allowed to reach a desired temperature. When in this vertical position, the body substantially acts as a chimney for rapid heating of the fuel. Once the fuel reaches the desired temperature, the body is rotated from the vertical position to the horizontal position. Food can be placed on the removable tray assembly and the tray assembly slid into the body, with the bottom member resting and sliding on the tray support members. The food is heated to a desired degree of doneness. If additional fuel is needed during the cooking process, additional fuel can be added into the body through the access port.

Other features and advantages of the invention will be apparent from the following detailed description taken in conjunction with the following figures, wherein like reference numerals represent like features.

### BRIEF DESCRIPTION OF THE FIGURES

FIG. 1 is a front perspective view of a cooking apparatus according to the present invention.

FIG. 2 is a front perspective view of a cooking apparatus according to the present invention with a removable tray assembly partially removed.

FIG. 3 is a rear perspective view of a cooking apparatus according to the present invention.

FIG. 4 is a front perspective view of the removable tray assembly according to the present invention.

FIG. 5 is a rear perspective view of the removable tray assembly according to the present invention.

FIG. 6 is a perspective view of a cooking apparatus according to the present invention with the removable tray assembly resting on the tray support members.

FIG. 7 is a perspective view of a cooking apparatus according to the present invention with the removable tray assembly in an alternate position resting on tray support members.

FIG. 8 shows the cooking apparatus according to the present invention, without the removable tray assembly, in a vertical position.

FIG. 9 shows the cooking apparatus according to the present invention with the removable tray assembly placed laterally across the top of the body of the apparatus.

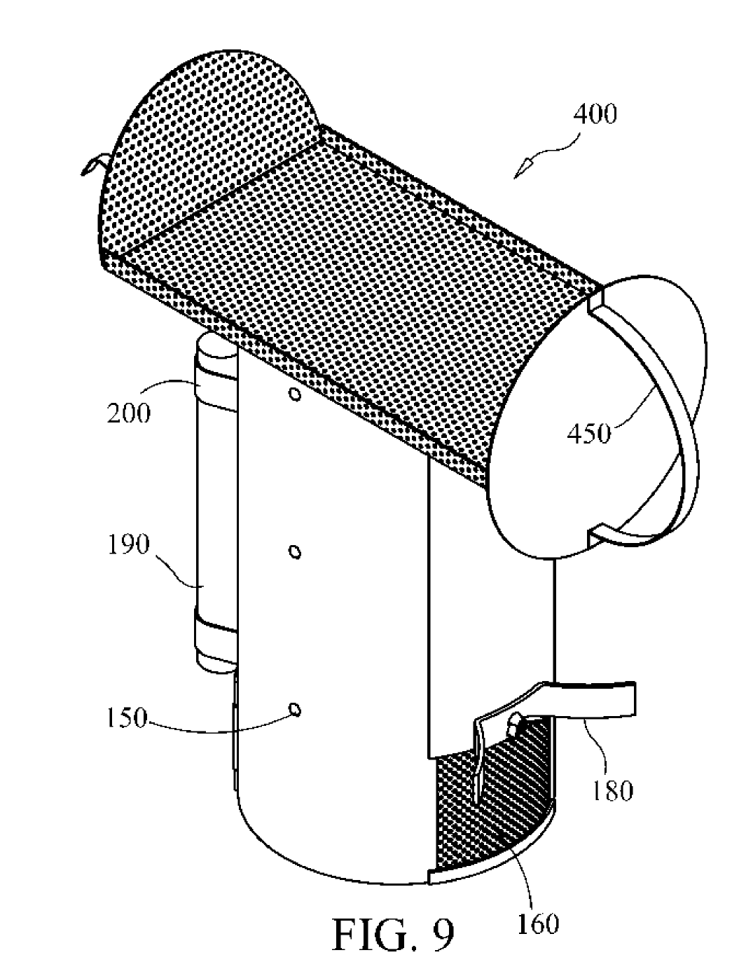

FIG. 10 shows an alternate embodiment of a cooking apparatus according to the present invention.

FIG. 11 shows the alternate embodiment of a cooking apparatus according to the present invention from FIG. 10 with the apparatus in a vertical position.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

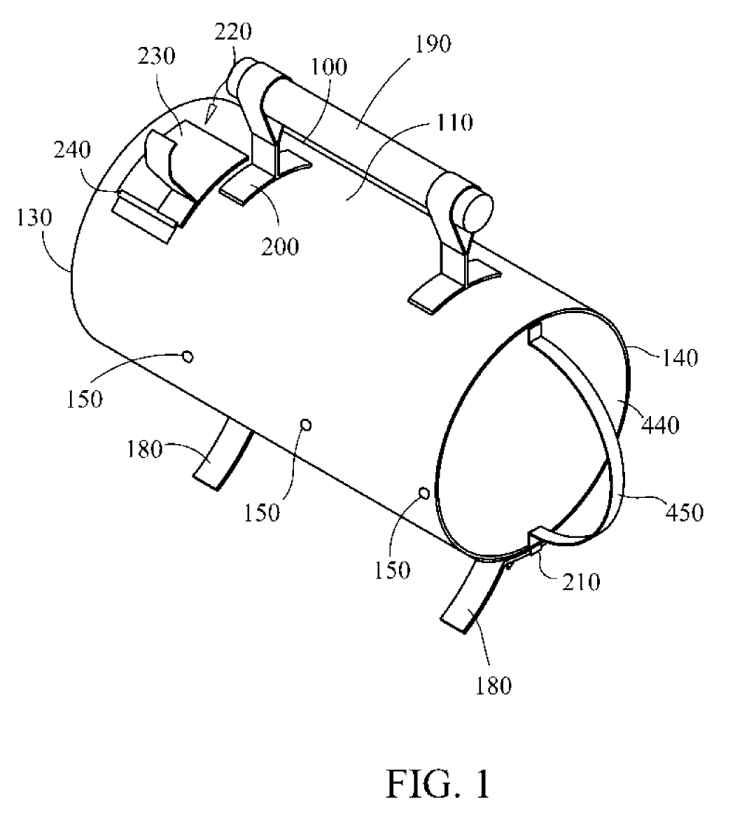

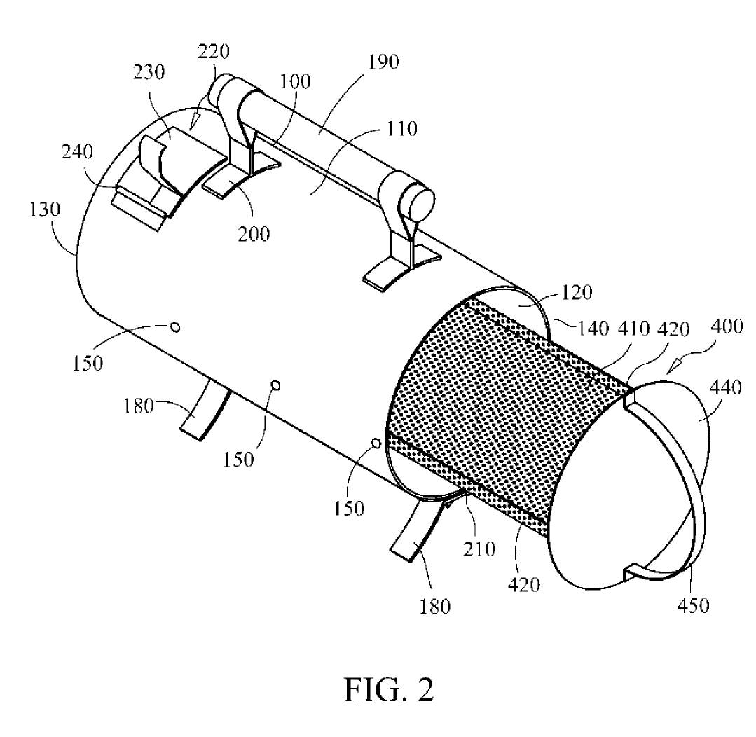

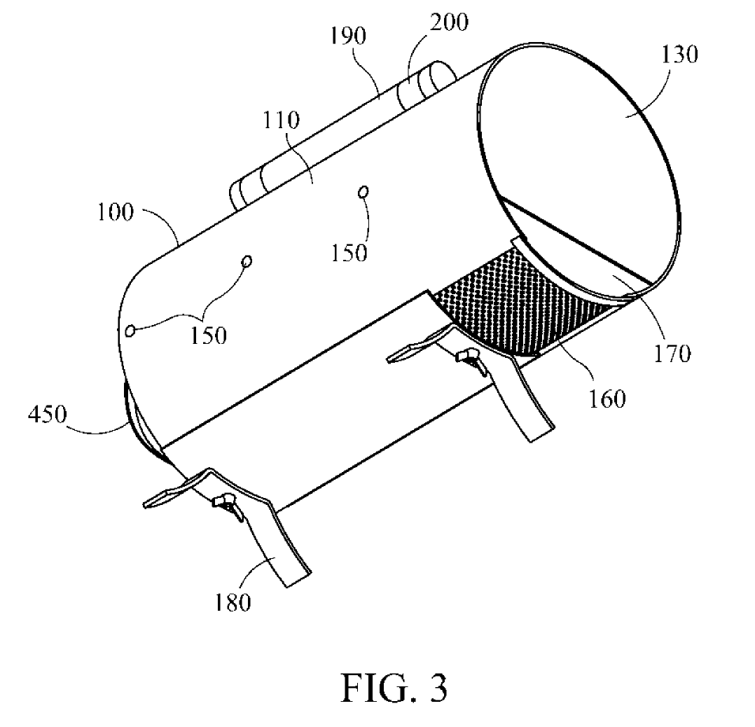

The present invention is a cooking apparatus. FIG. 1 is a front perspective view of a cooking apparatus according to the present invention. The cooking apparatus has two primary components: a substantially cylindrical body 100 and a removable tray assembly 400. FIG. 2 is a front perspective view of a cooking apparatus according to the present invention with a removable tray assembly partially removed. FIG. 3 is a rear perspective view of a cooking apparatus according to the present invention.

The substantially cylindrical body 100 has an outer surface 110 and an inner surface 120, a substantially closed first end 130, and an open second end 140. The inner surface 120 and the first end 130 define a cooking chamber. The substantially cylindrical shape of the body 100 and the first end 130 act to reflect heat into the cooking chamber and by extension onto food placed on the removable tray assembly 400. Tray support members 150 are disposed laterally across the interior of the body 100. The tray support members 150 serve to support the removable tray assembly 400 in various positions. An air inlet 160, preferably located on the bottom of the body 100 and near the first end 130, allows air into the cooking chamber to promote combustion of the combustible fuel used in the apparatus. Typically, the combustible fuel will be charcoal of various types, although other fuels may be used. An ash exit port 170 can be located towards the bottom of the first end 130. The ash exit port allow for ashes, created by the combustion process of the combustible fuel, to exit the body 100. Legs 180 may be used to support the body 100 up off the ground or other object the apparatus is placed upon and prevent the body 100 from rolling.

In various preferred embodiments, the body 100 also includes an access port 220 to allow access into the cooking chamber. Primarily the access port 220 is used to add additional combustible fuel into the cooking chamber during the cooking process. Preferably, the access port 220 is selectively covered by an access cover 230. The access cover 230 can be secured to the body 100 via a hinge 240, preferably a spring-loaded hinge, or similar mechanism.

A handle assembly, including a handle support 200 and handle 190 may also be connected to the body 100. Preferably the handle support 200 holds the handle 190 a sufficient distance from the outer surface 110 of the body 100 to permit grasping of the handle 190 by a user wearing a glove or oven type mitt. Furthermore, it is preferable if the handle 190 is constructed a heat resistant or insulating material. By way of example, and not by way of limitation, the handle 190 can be constructed from a wooden dowel.

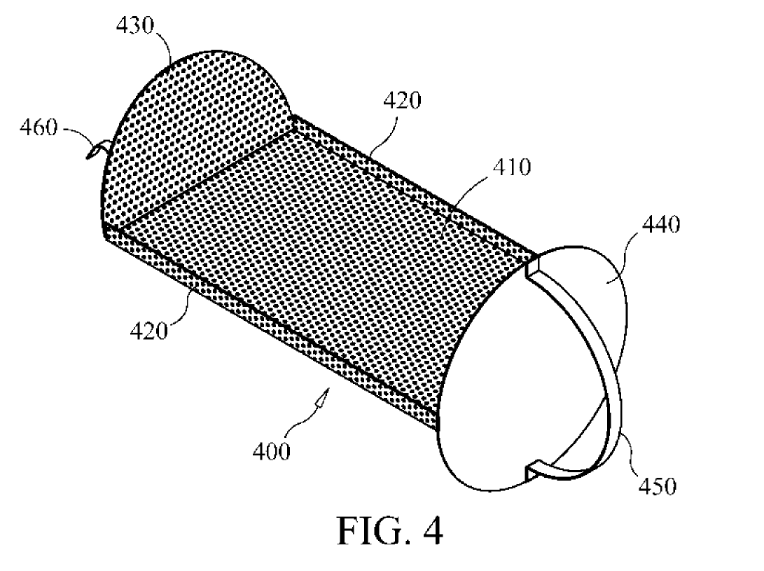

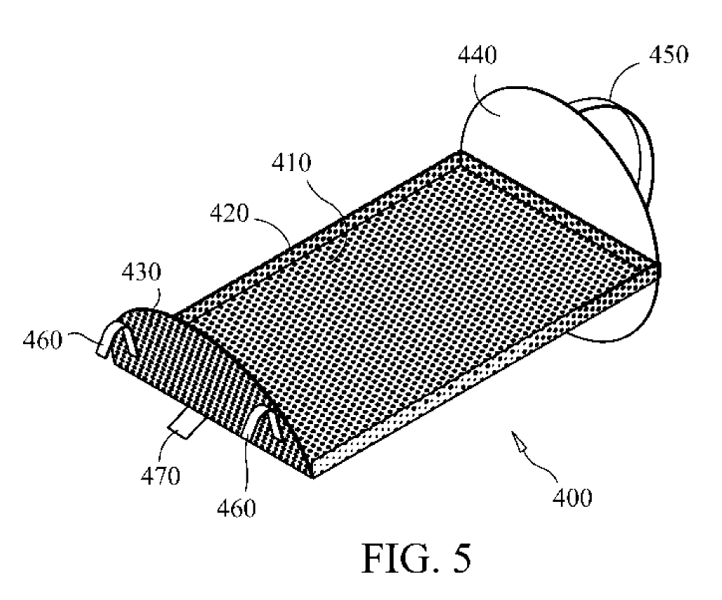

The removable tray assembly 400 includes a food receiving grate having a bottom member 410 and a substantially circular lid member 440. FIG. 4 is a front perspective view of the removable tray assembly according to the present invention. FIG. 5 is a rear perspective view of the removable tray assembly according to the present invention. A tray handle 450 may be connected to the lid member 440. The food receiving grate may also include a pair of side members 420 connected to and substantially perpendicular to the bottom member 410, and a back member 430 connected to and substantially perpendicular to the bottom member 410. An L-shaped tab 210 may also be connected to the body 100 for retaining the lid member 440 in a closed position, which is with the tray assembly fully slid into the body 100.

Preferably the back member 430 is substantially semi-circular in shape and substantially contoured to correspond to the inner surface 120 of said body 100. When so shaped, the back member 430 can rest against the inner surface 120 as the removable tray assembly 400 is slid out from the body 100. This permits the tray assembly 400 to be pulled any desired distance out of the body 100 without the tray assembly 400 tipping out of the body 100. The back member 430 can also serve to separate the food being cooked from the combustible fuel, particularly when the body 100 is either intentionally or accidentally tipped backward towards the first end 130. For example, when more intense direct heating of the food is desired, the back member 430 can be the cooking surface for the food and the body 100 placed in the vertical position for the cooking process.

Selective positioning of food on the food receiving grate allows for direct or indirect heating of the food. For example, placing food nearest the lid member 440 results in mostly indirect heating, where heat radiates from the combustible fuel located near the first end 130 through the body 100 to the food. Placing food furthest from the lid member 440 puts the food closer to the combustible fuel near the first end 130, which results in direct heating of the food. Furthermore, the removable tray assembly 400 can selectively slide in an out of the circular body 100, which permits more control of the direct and indirect nature of the cooking process.

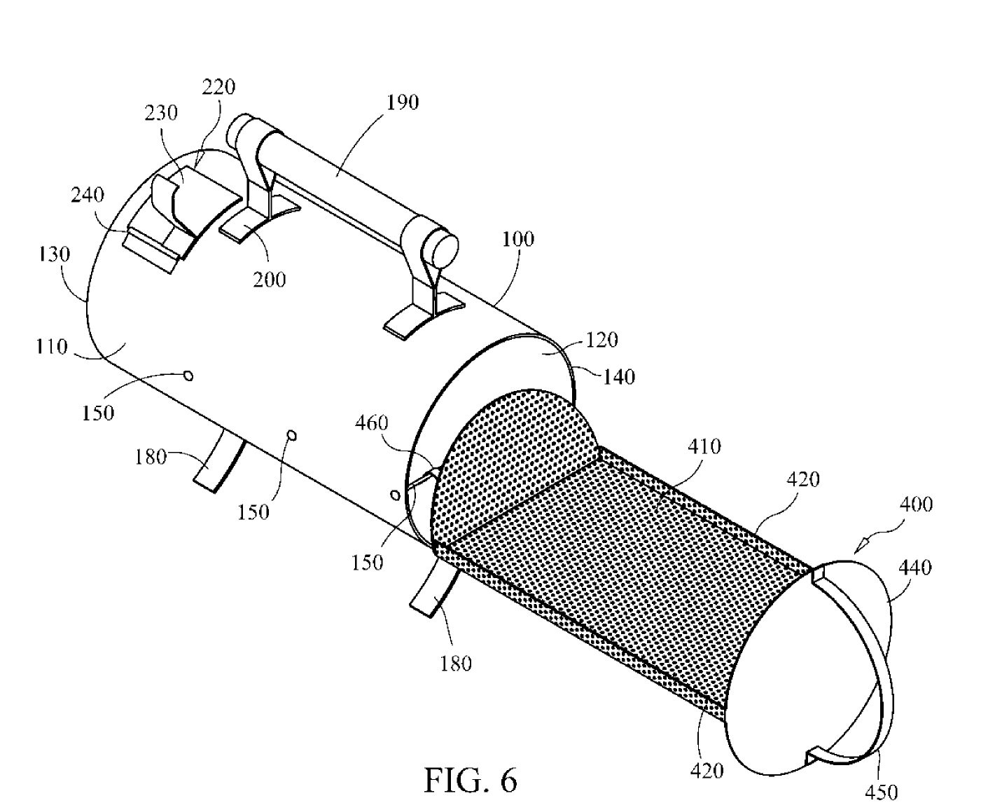

Referring to FIG. 6, which is a perspective view of a cooking apparatus according to the present invention with the removable tray assembly resting on the tray support members, the back member 430 may have at least one U-shaped tab 460 connected to the back member 430. The U-shaped tab 460 is configured rest on the tray support member 150 nearest to second end 140 when the tray assembly 400 is removed from the body 100.

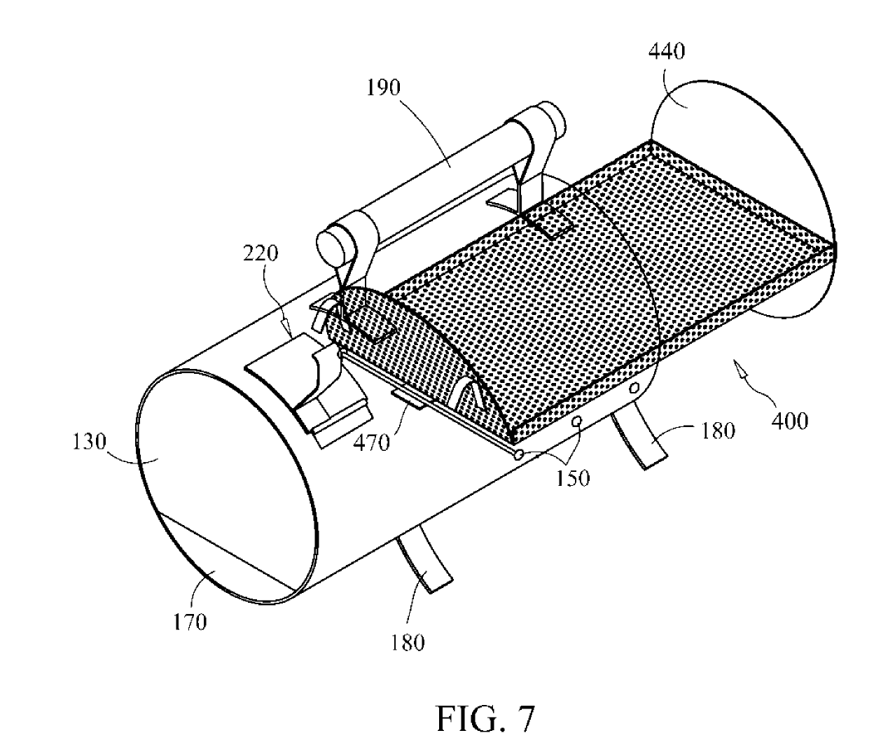

Referring to FIG. 7, which is a perspective view of a cooking apparatus according to the present invention with the removable tray assembly in an alternate position resting on tray support members, a cantilever tab 470 connected to and extended from either the back member 430 or the bottom member 410, where the said cantilever tab 470 is substantially parallel to the bottom member 410. The cantilever tab 470 is positioned and configured to fit under one of the tray support members 150 while the bottom member 410 rests upon another one the tray support members 150.

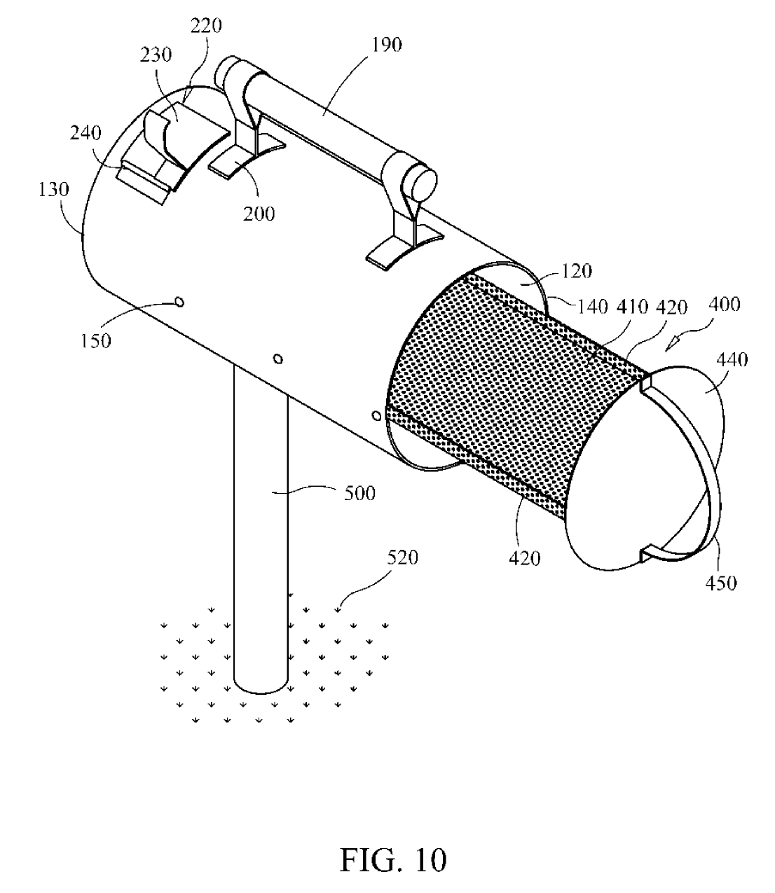

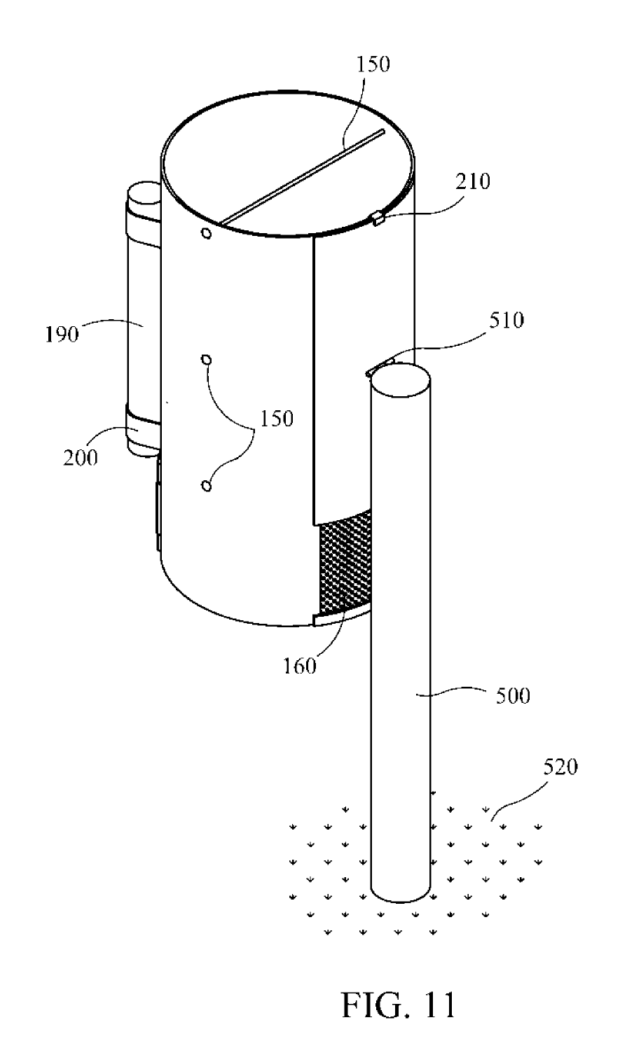

In various preferred embodiments, the cooking apparatus of the present invention can be affixed to a pole having one end in the ground. FIG. 10 shows an alternate embodiment of a cooking apparatus according to the present invention. FIG. 11 shows the alternate embodiment of a cooking apparatus according to the present invention from FIG. 10 with the apparatus in a vertical position. As shown in FIGS. 10 and 11, a pole 500 had one end in the ground 520 and the other end connected to the substantially cylindrical body 100. Preferably a hinge 510 connects the pole 500 to the body 100. The hinge 510 permits moving the body 100 between a vertical position and a horizontal position. In other preferred embodiments, the cooking apparatus of the present invention can be affixed to a bracket or other object used to mount the apparatus in a desired location.

With the exception of the handle 190 being constructed from heat resistant or insulating material, the remainder of the cooking apparatus components can be any suitable materials. Preferably these various components are constructed from stainless steel.

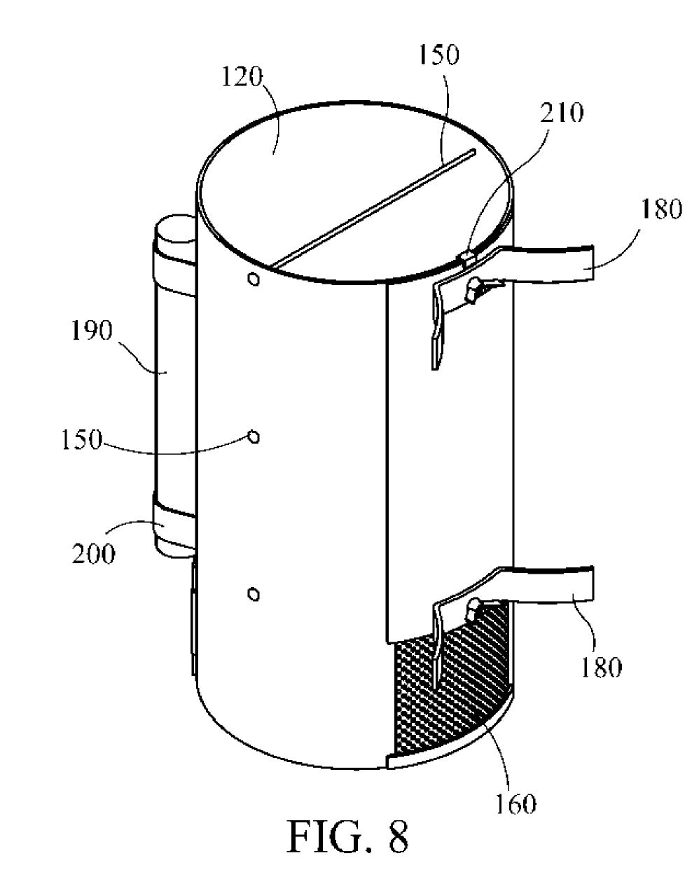

In use, the body 100 is placed in a vertical position, shown in FIG. 8, with the first end 130 down. A combustible fuel, such as charcoal, is placed into the body 100. The fuel is ignited and allowed to reach a desired temperature. When in this vertical position, the body 100 substantially acts as a chimney for rapid heating of the fuel. Once the fuel reaches the desired temperature, the body 100 is rotated from the vertical position to the horizontal position. Food can be placed on the removable tray assembly 400 and the tray assembly slid into the body 100, with the bottom member 410 resting and sliding on the tray support members 150. The food is heated to a desired degree of doneness. If additional fuel is needed during the cooking process, additional fuel can be added into the body 100 through the access port 220.

While the fuel is heating to its desired temperature, the removable tray assembly 400 can be heat cleaned by either placing the removable tray assembly laterally across the second end 140 or using the cantilever tab 470 to engage one of the tray support members 150 and hold the removable tray assembly 400 vertically in the body 100.

While specific embodiments have been illustrated and described, numerous modifications come to mind without significantly departing from the spirit of the invention and the scope of protection is limited by the scope of the accompanying claims.

What is claimed is:

1. A cooking apparatus comprising:
a substantially cylindrical body, having an inner surface and an outer surface, a substantially closed first end, and an open second end, said inner surface and said first end defining a cooking chamber,
a plurality of tray support members, said support members laterally disposed across said inner surface of said body,
at least one air inlet disposed along said cylindrical body, and
a removable tray assembly comprising a food receiving grate having a bottom member and a substantially circular lid member, wherein said food receiving grate connects to said lid member, and a tray handle connected to said lid member, wherein said removable tray assembly is removable from said body, and wherein said tray assembly rests and slides upon said tray support members.

2. The cooking apparatus according to claim 1, wherein said removable tray assembly further comprises:
a pair of side members connected to and substantially perpendicular to said bottom member, and
a back member connected to and substantially perpendicular to said bottom member.

3. The cooking apparatus according to claim 2, wherein said back member is substantially semi-circular in shape and substantially contoured to correspond to said inner surface of said body.

4. The cooking apparatus according to claim 3 further comprising at least one U-shaped tab connected to said back member, wherein said at least one U-shaped tab rest on said tray support members nearest to said second end when said tray assembly is removed from said body.

5. The cooking apparatus according to claim 2, further comprising a cantilever tab connected to and extended from one of said back member or said bottom member, said cantilever tab being substantially parallel to said bottom member, wherein said cantilever tab fits under one of said plurality of tray support members and said bottom member rests upon another one of said plurality of tray support members.

6. The cooking apparatus according to claim 1, wherein said substantially closed first end comprises an ash port opening.

7. The cooking apparatus according to claim 1, wherein said body further comprises an access door hingedly connected to said outer surface, said access door selectively covering an access port disposed in said body.

8. The cooking apparatus according to claim 1 further comprising a handle assembly connected to said outer surface.

9. The cooking apparatus according to claim 8, wherein said handle assembly comprises at least one handle support and a handle.

10. The cooking apparatus according to claim 9, wherein said second handle comprises a wooden dowel section.

11. The cooking apparatus according to claim 1, wherein said body further comprises an L-shaped lid retaining tab, said lid retaining tab extending from said body beyond said second end, wherein said L-shaped lid retaining tab prevents said removable tray assembly from unintentionally sliding out of said body.

12. The cooking apparatus according to claim 1 further comprising a plurality of leg members connected to said body.

13. The cooking apparatus according to claim 1 further comprising a mounting pole hingedly connected to said body.

14. The cooking apparatus according to claim 1, wherein said body, said tray support members, and said removable tray assembly are constructed from stainless steel.

15. A method of preparing food comprising the steps of:
positioning a cooking apparatus comprising a cylindrical body, having an inner surface and an outer surface, a substantially closed first end, and an open second end, a plurality of tray support members, said support members laterally disposed across said inner surface of said body, and at least one air inlet disposed along said cylindrical body in a vertical orientation with said substantially closed first end down,
adding a combustible fuel into said body,
igniting said combustible fuel
allowing said combustible fuel to reach a desired temperature,
rotating said cooking apparatus from said vertical orientation to a horizontal orientation,
placing food onto a removable tray assembly comprising a food receiving grate having a bottom member and a substantially circular lid member, wherein said food receiving grate connects to said lid member, and a tray handle connected to said lid member, wherein said removable tray assembly is removable from said body, and wherein said tray assembly rests and slides upon said tray support members,
sliding said removable tray assembly into said cylindrical body, and
heating said food to a desired degree of doneness.

16. The method of preparing food according to claim 15 further comprising the steps of:
placing said bottom member of said food receiving grate across said open second end after igniting said combustible fuel and while allowing said combustible fuel to reach a desired temperature, and
heat-cleaning said food receiving grate.

17. The method of preparing food according to claim 15, wherein said removable tray assembly further comprises a pair of side members connected to and substantially perpendicular to said bottom member, a back member connected to and substantially perpendicular to said bottom member, and a cantilever tab connected to and extended from one of said back member or said bottom member, said cantilever tab being substantially parallel to said bottom member, the method further comprises the steps of:
placing said cantilever tab on one side of one of said plurality of tray support members and resting said bottom member against another one of said plurality of tray support members after igniting said combustible fuel and while allowing said combustible fuel to reach a desired temperature, and
heat-cleaning said food receiving grate.

18. The method of preparing food according to claim 14, wherein said cylindrical body further comprises an access door hingedly connected to said outer surface, said access door selectively covering an access port disposed in said body, the method further comprising the steps of:
opening said access door,
adding additional combustible fuel into said cylindrical body through said access port, and
closing said access door.
